(19) United States
(12) Patent Application Publication
(10) Pub. No.: US 2006/0072622 A1
(43) Pub. Date: Apr. 6, 2006

(54) IP set-top box

(76) Inventor: Won-Sang Cho, Seoul (KR)

Correspondence Address: Robert E. Bushnell, Suite 300, 1522 K Street, N.W., Washington, DC, 20005-1202, US

(21) Appl. No.: 11/234,213

(22) Filed: Sep. 26, 2005

(30) Foreign Application Priority Data
Oct. 5, 2004 (KR) 2004-79281

(51) Int. Cl. H04H 1/04

(52) U.S. Cl. 370/486

(57) ABSTRACT

An Internet Protocol (IP) set-top box, adapted to provide functions of local wireless communication and voice communication while providing a broadcast service on the basis of an IP, includes: a broadcast data receiving unit adapted to request a broadcast service using the IP, to receive broadcast data transmitted as an IP packet in response to the request, and to decode the received broadcast data into a displayable format; a Wireless Local Area Network (WLAN) communication unit connected to the broadcast data receiving unit, the WLAN communication unit adapted to provide services for wireless data communication and voice communication using the IP in a WLAN; a voice communication unit adapted to provide analog voice communication and voice communication using the IP; and a microcomputer adapted to determine kinds of service of an IP packet received from the outside and an IP packet outputted from the broadcast data receiving unit, the WLAN communication unit, and the voice communication unit with reference to information on the kinds of service included in the IP packet, and to control transmission paths of the IP packets according to the result of the determination.

### CLAIM OF PRIORITY

This application makes reference to, incorporates the same herein, and claims all benefits accruing under 35 U.S.C. §119 from an application for IP SET-TOP BOX FOR PROVIDING LOCAL AREA WIRELESS COMMUNICATION AND VOICE COMMUNICATION FUNCTION earlier filed in the Korean Intellectual Property Office on 5 Oct. 2004 and there duly assigned Serial No. 2004-079281.

### BACKGROUND OF THE INVENTION

1. Field of the Invention

The present invention relates to a broadcast-communication convergence set-top box, and more specifically, to a broadcast-communication convergence set-top box having a local area communication service function in addition to a general broadcast signal reception function wherein video data is received via an Internet Protocol (IP) network and outputted to a display apparatus such as a TV set.

2. Description of the Related Art

A set-top box having a function of receiving a broadcast signal through an IP network is referred to as an IP set-top box (also referred to as an IP-STB). The IP set-top box is equipment with which a TV set performs a networking function.

In the IP set-top box, one end is connected to an Internet line connected to an external Internet network and the other end is connected to a TV set to provide a function of networking with the Internet via the TV set, in the same manner as networking performed using a computer and a monitor connected to the Internet.

When the IP set-top box is networking using the TV set, it can implement not only existing manual broadcast tasks but can also implement interactive broadcast services by networking, i.e., Video on Demand (VOD) broadcast services, as well as simple web surfing. Accordingly, a service provider can provide a subscriber with an interactive service through the IP set-top box, and the subscriber can be provided with additional information related to an existing broadcast and various additional services that are related to the broadcast.

The application of such an IP set-top box include broadcast guide information, an Internet service, movies on-line VOD such as a movie and music, on/off line games, and a karaoke system.

In a cable set-top box and a satellite set-top box, a subscriber can select a desired channel by controlling a tuner of a receiving unit to receive a broadcast signal. However, the IP set-top box provides the subscriber with a function of transmitting information on desired channels to a server used to provide the broadcast signal and receiving the broadcast signals (video/audio data) of the desired channels from the server.

Video/audio IP packets transferred through Ethernet are received into a physical layer (PHY) chip. The physical layer chip converts the received IP packets to be recognized in the IP set-top box and outputs them to a microcomputer (MICOM).

The microcomputer analyzes the IP packets that are converted into a recognizable format and inputted in the IP set-top box, and separates a Motion/moving Picture Export Group Transport Stream (MPEG TS) in which the video/audio broadcast data are integrated from the IP packets. The microcomputer outputs the MPEG TS separated from the IP packets to an MPEG decoder.

The MPEG decoder analyzes the MPEG TS and divides it into video data and audio data. The MPEG decoder outputs the video data to a video encoder, and outputs the audio data to an audio CODEC.

The video encoder converts the video data received from the MPEG decoder into a video output signal corresponding to a display standard of a display device that displays the video data and outputs the converted signal. The video output signal can be a composite signal, a component signal, or a super video signal, for example.

The audio CODEC converts the audio data received from the MPEG decoder into stereo or Sony/Philips Digital Interface (S/PDIF) audio output signal and outputs the converted signal.

A display unit displays the video output signal outputted from the video encoder under the control of the microcomputer. An infrared receiving unit receives an operation instruction of the IP set-top box transmitted from a remote control and inputs the operation instruction to the microcomputer. The microcomputer performs the corresponding operation according to the operation instruction from the infrared receiving unit.

The IP set-top box described above is generally connected to an xDSL or Ethernet network directly to be provided with IP-based broadcast information. Accordingly, the IP set-top box has a bandwidth of 4 Mbps actually occupied and used, although it has a bandwidth of 10 to 15 Mbps provided through a connected transmission line. Therefore, there is a need for a method to utilize the bandwidth provided to the IP set-top box.

In order to satisfy such a need, a method has been recently suggested in which a LAN switch is added in the IP set-top box and is selectively used in Internet-based data communication such as a computer. However, adding the LAN switch in the IP set-top box has a problem in that home must have a separate IP in addition to the IP assigned for broadcasting.

Therefore, there is a need for efficient utilization of a network bandwidth and provision of a new service by providing an additional network, while maintaining an existing network for a computer or the like at home although the IP set-top box is installed.

### SUMMARY OF THE INVENTION

It is, therefore, an object of the present invention to provide an IP set-top box that can more efficiently utilize a bandwidth assigned in a transmission line in order to transmit a broadcast signal using IP.

It is another object of the present invention to provide an IP set-top box that can provide at least one of data and voice communication services as well as a broadcast service using IP.

It is yet another object of the present invention to provide an IP set-top box that can integrally provide a Voice over Internet Protocol (VoIP) using IP and an access point for Wireless Local Area Network (WLAN) communication in additional to a broadcast service using the IP.

According to an aspect of the present invention, an (Internet protocol) IP set-top box comprises: a broadcast data receiving unit adapted to request a broadcast service using the IP, to receive broadcast data transmitted as an IP packet in response to the request, and to decode the received broadcast data into a displayable format; a Wireless Local Area Network (WLAN) communication unit connected to the broadcast data receiving unit, the WLAN communication unit adapted to provide services for wireless data communication and voice communication using the IP in a WLAN; a voice communication unit adapted to provide analog voice communication and voice communication using the IP; and a microcomputer adapted to determine kinds of service of an IP packet received from the outside and an IP packet outputted from the broadcast data receiving unit, the WLAN communication unit, and the voice communication unit with reference to information on the kinds of service included in the IP packet, and to control transmission paths of the IP packets according to the result of the determination.

The WLAN communication unit preferably comprises an Access Point (AP) adapted to respectively form wireless channels with a WLAN terminal for wireless data communication and a voice communication terminal for voice communication using the IP and to provide interfaces to the microcomputer with respect to the WLAN terminal and the voice communication terminal.

The AP preferably comprises: a WLAN modem adapted to communicate with the microcomputer and to convert and output a bandwidth of an inputted signal into a baseband; and a WLAN Radio Frequency(RF) unit adapted to perform up-conversion of signals inputted from the WLAN modem and to transmit the up-converted signals to the WLAN terminal and the voice communication terminal via a wireless network and to perform down-conversion of signals received from the WLAN terminal and the voice communication terminal via the wireless network and to output the down-converted signals to the WLAN modem.

The voice communication unit preferably comprises: a Voice over Internet Protocol (VoIP) modem adapted to convert and output a voice communication IP packet inputted from the WLAN communication unit and an external transmission network and voice data inputted via an analog port into a voice packet for voice communication using the IP; and a Coder/Decoder (CODEC) adapted to convert and output the voice packet outputted from the VoIP modem into an analog voice band and to perform pulse code modulation of voice data inputted via the analog port and to output the modulated data to the VoIP modem.

The IP set-top box preferably further comprises an interface connected to a camera module adapted to take an image, wherein the microcomputer receives the image taken by the camera module connected to the interface to control a transmission path for image communication.

According to another aspect of the present invention, an Internet Protocol (IP) set-top box comprises: a broadcast data receiving unit adapted to request a broadcast service using the IP, to receive broadcast data transmitted as an IP packet in response to the request, and to decode the received broadcast data into a displayable format; a Wireless Local Area Network (WLAN) communication unit connected to the broadcast data receiving unit, the WLAN communication unit adapted to provide services for wireless data communication and voice communication using the IP in a WLAN; a voice communication unit adapted to provide an analog voice communication function and a voice communication function using the IP; a first microcomputer adapted to determine kinds of service of an IP packet received from the outside and an IP packet outputted from the broadcast data receiving unit, the WLAN communication unit, and the voice communication unit with reference to information on kinds of service included in the IP packet, and to control transmission paths of the IP packets according to the result of the determination; and a second microcomputer adapted to control operations of the WLAN communication unit and the voice communication unit to perform the wireless data communication and the voice communication using the IP under the control of the first microcomputer.

The WLAN communication unit preferably comprises an Access Point (AP) adapted to respectively form wireless channels with a WLAN terminal for wireless data communication and a voice communication terminal for voice communication using the IP and to provide interfaces to the second microcomputer with respect to the WLAN terminal and the voice communication terminal.

The AP preferably comprises: a WLAN modem adapted to communicate with the second microcomputer and to convert and output a bandwidth of an inputted signal into a baseband; and a WLAN RF unit adapted to perform up-conversion of signals inputted from the WLAN modem and to transmit the up-converted signals to the WLAN terminal and the voice communication terminal via a wireless network, and to perform down-conversion of signals received from the WLAN terminal and the voice communication terminal via the wireless network and to output the down-converted signals to the WLAN modem.

The voice communication unit preferably comprises: a Voice over Internet Protocol (VoIP) modem adapted to convert and output a voice communication IP packet inputted from the WLAN communication unit and an external transmission network and voice data inputted via an analog port into a voice packet for voice communication using the IP; and a Coder/Decoder (CODEC) adapted to convert and output the voice packet outputted from the VoIP modem into an analog voice band and to perform pulse code modulation of voice data inputted via the analog port and to output the modulated data to the VoIP modem.

The IP set-top box preferably further comprises an interface connected to a camera module used to take an image, wherein the first microcomputer receives the image taken by the camera module connected to the interface and to control a transmission path for image communication.

According to the present invention, it is possible to provide data and voice communication services as well as a broadcast service by including an AP for data communication, a VoIP modem for voice communication and a module for voice communication in an IP-based broadcast service set-top box.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a block diagram of an IP set-top box;

FIG. 2 is a block diagram of a first embodiment of an IP-based broadcast IP set-top box that provides services for WLAN communication and VoIP in accordance with the present invention; and

FIG. 3 is a block diagram of a second embodiment of an IP-based broadcast IP set-top box that provides services for WLAN communication and VoIP in accordance with the present invention.

### DETAILED DESCRIPTION OF THE INVENTION

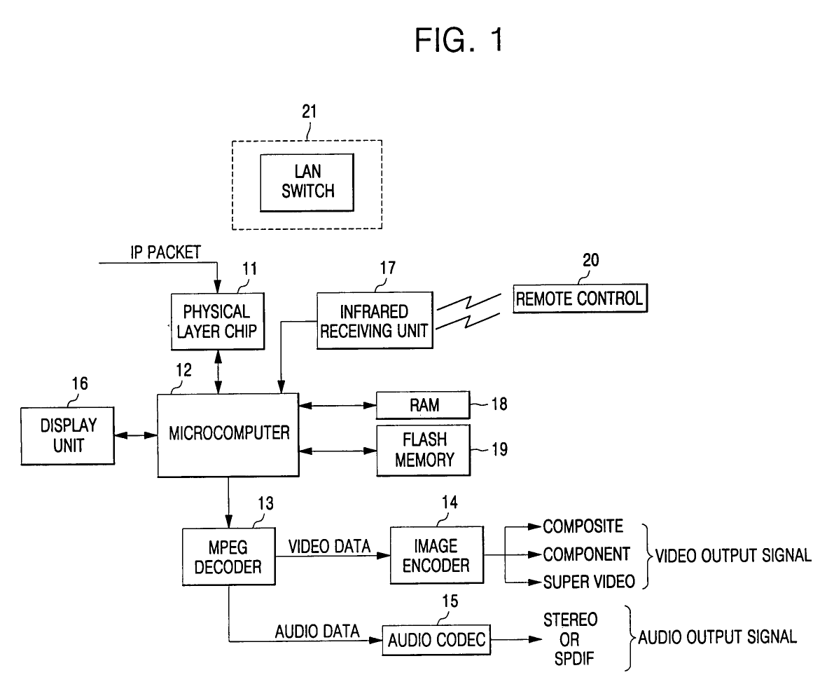

FIG. 1 is a block diagram of an IP set-top box.

In a cable set-top box and a satellite set-top box, a subscriber can select a desired channel by controlling a tuner of a receiving unit to receive a broadcast signal. However, the IP set-top box provides the subscriber with a function of transmitting information on desired channels to a server used to provide the broadcast signal and receiving the broadcast signals (video/audio data) of the desired channels from the server.

Video/audio IP packets transferred through Ethernet are received into a physical layer (PHY) chip 11. The physical layer chip 11 converts the received IP packets to be recognized in the IP set-top box and outputs them to a microcomputer (MICOM) 12.

The microcomputer 12 analyzes the IP packets that are converted into a recognizable format and inputted in the IP set-top box, and separates a Motion/moving Picture Export Group Transport Stream (MPEG TS) in which the video/audio broadcast data are integrated from the IP packets. The microcomputer 12 outputs the MPEG TS separated from the IP packets to an MPEG decoder 13.

The MPEG decoder 13 analyzes the MPEG TS and divides it into video data and audio data. The MPEG decoder 13 outputs the video data to a video encoder 14, and outputs the audio data to an audio CODEC 15.

The video encoder 14 converts the video data received from the MPEG decoder 13 into a video output signal corresponding to a display standard of a display device that displays the video data and outputs the converted signal. The video output signal can be a composite signal, a component signal, or a super video signal, for example.

The audio CODEC 15 converts the audio data received from the MPEG decoder 13 into stereo or Sony/Philips Digital Interface (S/PDIF) audio output signal and outputs the converted signal.

A display unit 16 displays the video output signal outputted from the video encoder 14 under the control of the microcomputer 12. An infrared receiving unit 17 receives an operation instruction of the IP set-top box transmitted from a remote control 20 and inputs the operation instruction to the microcomputer 12. The microcomputer 12 performs the corresponding operation according to the operation instruction from the infrared receiving unit 17.

The IP set-top box described above is generally connected to an xDSL or Ethernet network directly to be provided with IP-based broadcast information. Accordingly, the IP set-top box has a bandwidth of 4 Mbps actually occupied and used, although it has a bandwidth of 10 to 15 Mbps provided through a connected transmission line. Therefore, there is a need for a method to utilize the bandwidth provided to the IP set-top box.

In order to satisfy such a need, a method has been recently suggested in which a LAN switch 21 is added in the IP set-top box and is selectively used in Internet-based data communication such as a computer. However, adding the LAN switch 21 in the IP set-top box has a problem in that home must have a separate IP in addition to the IP assigned for broadcasting.

Therefore, there is a need for efficient utilization of a network bandwidth and provision of a new service by providing an additional network, while maintaining an existing network for a computer or the like at home although the IP set-top box is installed. The present invention will now be described more fully hereinafter with reference to the accompanying drawings, in which exemplary embodiments of the present invention are shown. The present invention can, however, be embodied in different forms and should not be construed as being limited to the embodiments set forth herein. Rather, these embodiments are provided so that this disclosure will be thorough and complete, and will fully convey the scope of the present invention to those skilled in the art. In the drawings, like numbers refer to like elements throughout the specification.

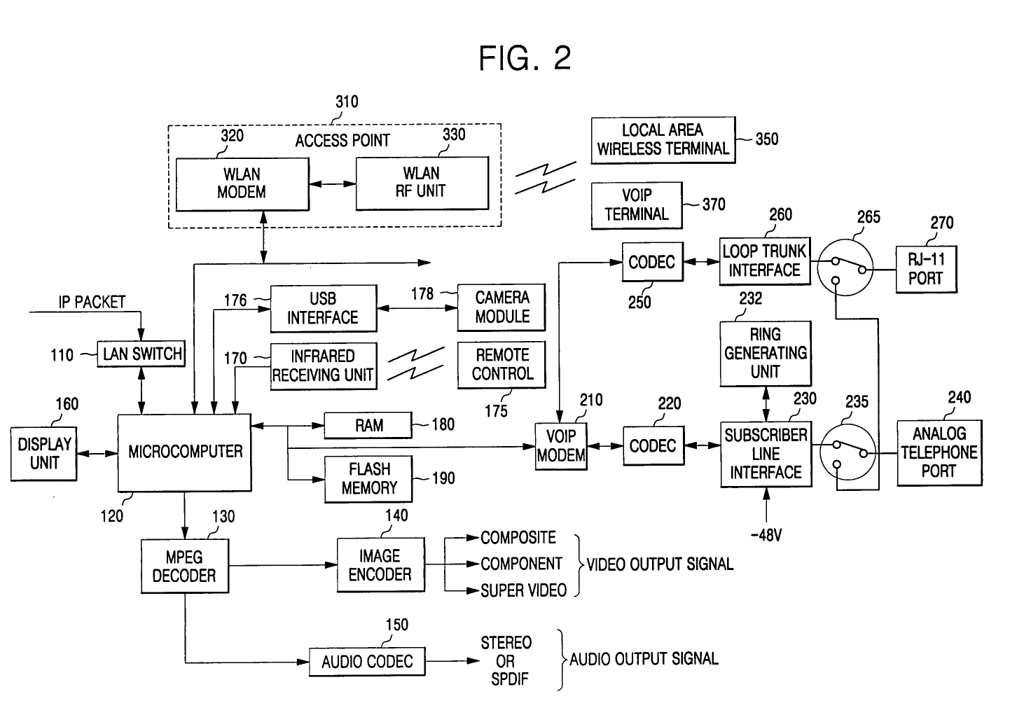

FIG. 2 is a block diagram of a first embodiment of an IP-based broadcast IP set-top box that provides services for WLAN communication and VoIP in accordance with the present invention.

Generally, an IP set-top box of the present invention can integrally provide a function for a broadcast service based on an IP, a function for a WLAN service, and a function for a VoIP service. Accordingly, the IP set-top box of the present invention will be described below.

Broadcast Service Using IP

IP packets for a broadcast where video and audio signals are integrated, IP packets for data communication, and IP packets for VoIP are received into a LAN switch 110 for a LAN interface. The LAN switch 110 converts the received IP packets into a format recognizable in the IP set-top box and outputs them to a microcomputer 120.

The microcomputer 120 analyzes the inputted IP packets that have been converted into the format recognizable in the IP set-top box and determines whether the IP packets are for broadcast, data communication or for VoIP. According to the result of the determination, the microcomputer 120 outputs the IP packets to modules that can process the packets. The microcomputer 120 outputs the IP packets to an MPEG decoder 130 when the IP packets are for broadcast, to an access point 310 when the IP packets are for data communication, and to a VoIP modem (modulator/demodulator) 210 when the IP packets are for VoIP.

The microcomputer 120 separates an MPEG TS from the IP packets when the IP packets are for broadcast. The microcomputer 120 outputs the MPEG TS separated from the IP packets to the MPEG decoder 130.

The MPEG decoder 130 analyzes the MPEG TS, and divides it into video data and audio data. The MPEG decoder 130 outputs the video data to a video encoder 140, and the audio data to an audio CODEC 150.

The video encoder 140 converts the video data received from the MPEG decoder 130 into a video output signal corresponding to a display standard of a display device that displays the video data and output the converted signal. The video output signal can be a composite signal, a component signal, or a super video signal, for example.

The audio CODEC 150 converts the audio data received from the MPEG decoder 130 into a stereo or S/PDIF audio output signal and outputs the converted signal.

A display unit 160 displays the video output signal outputted from the video encoder 140 under the control of the microcomputer 120. An infrared receiving unit 170 receives an operation instruction of the IP set-top box transmitted from a remote control 175 and inputs the operation instruction to the microcomputer 120. The microcomputer 120 performs the operation in accordance with the operation instruction provided from the infrared receiving unit 170.

Data Communication Service Using IP

An access point 310 provides a WLAN terminal 350 and a VoIP terminal 370 that are connected to the microcomputer 120 and positioned in a desired area, with a function for WLAN communication. The access point 310 is a baseband modem for WLAN communication, which has a WLAN modem 320 capable of supporting IEEE802.11 A/B/G, and a Wireless Local Area Network Radio Frequency (WLAN RF) unit 330 that performs up-conversion in order to wirelessly transmit signals outputted from the WLAN modem 320. Also, the WLAN RF unit 330 performs down-conversion of the signals received from the WLAN terminal 350 and the VoIP terminal 370 into a baseband and outputs the converted signals to the WLAN modem 320.

VoIP Service Using IP

The VoIP modem 210 converts the VoIP packets inputted through the WLAN terminal 350 and the VoIP terminal 370 or an external network, and voice data inputted from a general purpose telephone connected to an analog telephone port 240 into voice packets for the VoIP.

The CODEC 220 performs Pulse Code Modulation (PCM) of voice signals inputted from the analog telephone through the analog telephone port 240, or converts the PCM data into analog voice band signals. A ring generation unit 232 provides the general purpose telephone connected to the analog telephone port 240 with a signal used to ring the telephone. A voltage of −48V is inputted into a subscriber line interface 230, so that the subscriber line interface 230 feeds a direct current to the general purpose telephone connected to the analog telephone port 240. The analog telephone port 240 includes an RJ-11 port adapted to connect to a telephone line of the general purpose telephone.

The CODEC 250 connected to the VoIP modem 210 and a loop trunk interface 260 are used for a loop trunk structure. According to this embodiment, a structure is provided wherein a Public Switched Telephone Network (PSTN) office line (a telephone line) is connected using the CODEC 250 and the loop trunk interface 260 and the VoIP terminal 370 can perform voice communication using the PSTN office line.

A first switch 265 and a second switch 235 are used for Power Failure Transfer (PFT). That is, when a power failure occurs in the state that the PSTN office line and the telephone are connected to the IP set-top box, the switches are changed over and the office line and the telephone are connected to each other, so that the general purpose telephone can be used as is.

A Universal Serial Bus (USB) interface 176 connects an external USB unit such as a camera module 178 to the microcomputer 120. According to this embodiment, a method is provided wherein video phone and video transmission are performed using IP packets by connecting the USB interface 176 to the camera module 178.

Accordingly, by including the access point for data communication, the VoIP modem 210 for VoIP, and a module for VoIP in the IP-based set-top box for broadcast service, it is possible to provide data and VoIP communication services using wired/wireless terminals as well as a broadcast service.

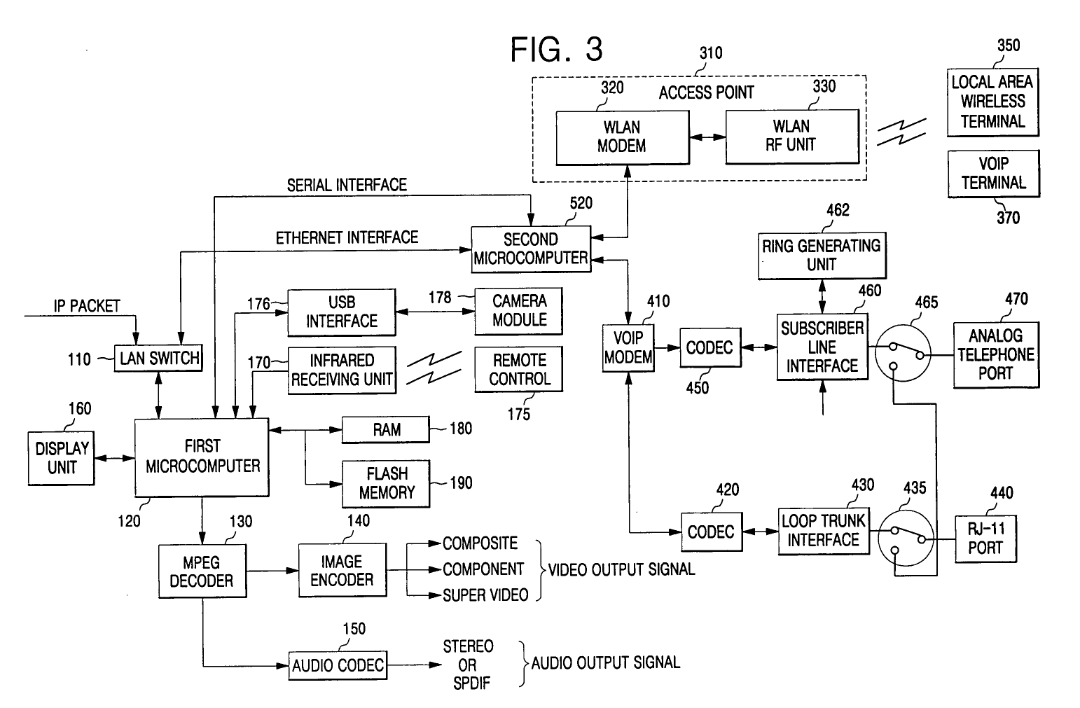

FIG. 3 is a block diagram of a second embodiment of an IP-based broadcast IP set-top box that provides services for WLAN communication and VoIP in accordance with the present invention.

Descriptions of technical features of blocks used to perform the same functions as those of FIG. 2 have been omitted or have been only explained briefly for the sake of brevity.

As shown in FIG. 3, since a significant load is required to process three different functions, that is, a broadcast service function, a WLAN communication service function and a VoIP function, the present embodiment includes a first microcomputer 120 and a second microcomputer 520 to reduce such load.

Referring to FIG. 2, when the IP set-top box includes only one microcomputer, a high performance microcomputer is needed so that the material cost is increased.

Accordingly, according to the present embodiment, the first microcomputer 120 performs a control operation for a broadcast service, and the second microcomputer 520 performs a control operation for WLAN communication and VoIP services.

The first and second microcomputers 120 and 520 are set to communicate with each other through a serial interface. Although the first and second microcomputers 120 and 520 operate individually in accordance with the present embodiment, the first microcomputer 120 is a master and the second microcomputer 520 is a slave. The first microcomputer 120 transmits IP packets for data communication and VoIP to the second microcomputer 520.

A LAN switch 110 and the second microcomputer 520 are connected to each other by a 10/100 base-T typed Ethernet interface.

An embodiment of a VoIP service using FIGS. 2 and 3 of the present invention is explained in detail below.

Call in Telephone Connected to VoIP Terminal and Telephone Port

The VoIP terminal 370 is assigned a dynamic IP from an IP set-top box when it is set up. The IP set-top box provides a lower VoIP terminal 370 with a local IP through a Dynamic Host Configuration Protocol (DHCP) using a Network Address Translation (NAT) function.

Then, the VoIP terminal 370 receives each distributed extension telephone number and uses the received numbers for the purpose of VoIP. The extension telephone numbers always remain in the same number using each MAC address of the VoIP terminal 370 even though the IP is changed.

When the VoIP terminal 370 tries to make a call, a signal caused by the trial is transferred to the microcomputer 120. The microcomputer 120 generates a ring in the analog telephone through the CODEC 220 by controlling the VoIP modem 210.

Voice signal transmission according to the ring generation is performed by the following procedures.

First, the VoIP terminal 370 compresses a read voice and transmits it using a wireless environment, and the voice data is transferred to the microcomputer 120 by the WLAN RF unit 330 and the WLAN modem 320.

The microcomputer 120 detects packets for VoIP among data received from the WLAN modem 320 and outputs them to the VoIP modem 210. The VoIP modem 210 converts the packets for VoIP received from the microcomputer 120 into PCM data. The converted voice data is transferred to the general purpose telephone via the CODEC 220, the subscriber line interface 230, and the analog telephone port 240.

VoIP Communication from VoIP Terminal to Outside

When communicating with the outside using the VoIP, VoIP compressed voice packets are transmitted to the outside by the microcomputer 120 and the LAN switch 110. An SIP server or a gatekeeper must be included in the external network.

Communication from VoIP Terminal to External PSTN Network

A communication structure of the present embodiment is aimed to communicate with the outside by the PSTN network using the VoIP terminal 370. According to such a communication structure, it is possible for the VoIP terminal 370 to make a call by the PSTN network, or the general purpose telephone or the VoIP terminal 370 connected to the PSTN network receiving a call made to the PSTN network from the outside.

During transmission, when a user pushes sign buttons (for example, #9) indicating that the user is making a call using the PSTN network and a telephone number in the VoIP terminal 370, call information is inputted into the microcomputer 120 via the WLAN RF unit 330 and the WLAN modem 320 in the present embodiment.

The microcomputer 120 transmits a Dual Tone Multi-Frequency (DTMF) signal via the CODEC 250 by controlling the VoIP modem 210. When the call is set up, a voice signal is transmitted to the external PSTN via the WLAN RF unit 330, the WLAN modem 320, the microcomputer 120, the VoIP modem 210, the CODEC 250, the loop trunk interface 260, and the RJ-11 port 270.

On the other hand, when a call is received from the outside via the PSTN, it is recognized in the loop trunk interface 260, causing a ring in the general purpose telephone and the VoIP terminal 370 connected to the analog telephone port 240. The loop trunk interface 260 senses a telephone set that is hooked for the first time, and makes connection of the VoIP.

External VoIP Communication in the General Purpose Telephone

When dialing is performed in the general purpose telephone set connected to the analog telephone port 240, the CODEC 220 recognizes the dialing and inputs it into the microcomputer 120 by the VoIP modem 210.

The microcomputer 120 converts a dialing signal received from the VoIP modem 210 into packets and then performs call initialization with an external SIP server. After that, the voice data is inputted into the VoIP modem 210 by the analog telephone port 240, the subscriber line interface 230, and the CODEC 220. The VoIP modem 210 converts the voice data into VoIP packets and transmits the packets to the outside by the microcomputer 120 and the LAN switch 110.

Video Communication

In data for the image communication according to the present embodiment, video signals are in a Motion Picture Expert Group 4 (MPEG4) or an H.263/264 format, and voice signals are transferred in a form of VoIP.

Signals for the image communication are classified by the microcomputer 120, wherein the video signals are outputted to the MPEG decoder 130 and the VoIP signals are outputted to the VoIP modem 210. Also, an image of a caller taken by a camera module 178 is encoded by the microcomputer 120 and transmitted to the outside as an IP packet via the LAN switch 110.

A telephone number of the other party and a Picture in Picture (PIP) can be displayed on a screen while performing the image communication.

Although a detailed example of the voice communication is described with reference to FIG. 2, the example of the voice communication can also be applied in the same manner with reference to FIG. 3. Accordingly, the example of the voice communication described with reference to FIG. 2 has been omitted.

According to the present invention, it is possible to provide data and voice communication services using wired/wireless terminals as well as a broadcast service by including an access point for data communication, a VoIP modem for voice communication and a module for voice communication in an IP-based broadcast service set-top box.

Although exemplary embodiments of the present invention have been described, it will be understood by those skilled in the art that the present invention is not limited to the described exemplary embodiments. Rather, various changes and modifications can be made within the spirit and scope of the present invention, as defined by the following claims.

What is claimed is:

1. An Internet Protocol (IP) set-top box comprising:
a broadcast data receiving unit adapted to request a broadcast service using the IP, to receive broadcast data transmitted as an IP packet in response to the request, and to decode the received broadcast data into a displayable format;
a Wireless Local Area Network (WLAN) communication unit connected to the broadcast data receiving unit, the WLAN communication unit adapted to provide services for wireless data communication and voice communication using the IP in a WLAN;
a voice communication unit adapted to provide analog voice communication and voice communication using the IP; and
a microcomputer adapted to determine kinds of service of an IP packet received from the outside and an IP packet outputted from the broadcast data receiving unit, the WLAN communication unit, and the voice communication unit with reference to information on the kinds of service included in the IP packet, and to control transmission paths of the IP packets according to the result of the determination.

2. The IP set-top box according to claim 1, wherein the WLAN communication unit comprises an Access Point (AP) adapted to respectively form wireless channels with a WLAN terminal for wireless data communication and a voice communication terminal for voice communication using the IP and to provide interfaces to the microcomputer with respect to the WLAN terminal and the voice communication terminal.

3. The IP set-top box according to claim 2, wherein the AP comprises:
a WLAN modem adapted to communicate with the microcomputer and to convert and output a bandwidth of an inputted signal into a baseband; and
a WLAN Radio Frequency (RF) unit adapted to perform up-conversion of signals inputted from the WLAN modem and to transmit the up-converted signals to the WLAN terminal and the voice communication terminal via a wireless network and to perform down-conversion of signals received from the WLAN terminal and the voice communication terminal via the wireless network and to output the down-converted signals to the WLAN modem.

4. The IP set-top box according to claim 1, wherein the voice communication unit comprises:
a Voice over Internet Protocol (VoIP) modem adapted to convert and output a voice communication IP packet inputted from the WLAN communication unit and an external transmission network and voice data inputted via an analog port into a voice packet for voice communication using the IP; and
a Coder/Decoder (CODEC) adapted to convert and output the voice packet outputted from the VoIP modem into an analog voice band and to perform pulse code modulation of voice data inputted via the analog port and to output the modulated data to the VoIP modem.

5. The IP set-top box according to claim 1, further comprising an interface connected to a camera module adapted to take an image, wherein the microcomputer receives the image taken by the camera module connected to the interface to control a transmission path for image communication.

6. An Internet Protocol (IP) set-top box comprising:
a broadcast data receiving unit adapted to request a broadcast service using the IP, to receive broadcast data transmitted as an IP packet in response to the request, and to decode the received broadcast data into a displayable format;
a Wireless Local Area Network (WLAN) communication unit connected to the broadcast data receiving unit, the WLAN communication unit adapted to provide services for wireless data communication and voice communication using the IP in a WLAN;
a voice communication unit adapted to provide an analog voice communication function and a voice communication function using the IP;
a first microcomputer adapted to determine kinds of service of an IP packet received from the outside and an IP packet outputted from the broadcast data receiving unit, the WLAN communication unit, and the voice communication unit with reference to information on kinds of service included in the IP packet, and to control transmission paths of the IP packets according to the result of the determination; and
a second microcomputer adapted to control operations of the WLAN communication unit and the voice communication unit to perform the wireless data communication and the voice communication using the IP under the control of the first microcomputer.

7. The IP set-top box according to claim 6, wherein the WLAN communication unit comprises an Access Point (AP) adapted to respectively form wireless channels with a WLAN terminal for wireless data communication and a voice communication terminal for voice communication using the IP and to provide interfaces to the second microcomputer with respect to the WLAN terminal and the voice communication terminal.

8. The IP set-top box according to claim 7, wherein the AP comprises:
a WLAN modem adapted to communicate with the second microcomputer and to convert and output a bandwidth of an inputted signal into a baseband; and
a WLAN Radio Frequency (RF) unit adapted to perform up-conversion of signals inputted from the WLAN modem and to transmit the up-converted signals to the WLAN terminal and the voice communication terminal via a wireless network, and to perform down-conversion of signals received from the WLAN terminal and the voice communication terminal via the wireless network and to output the down-converted signals to the WLAN modem.

9. The IP set-top box according to claim 6, wherein the voice communication unit comprises:
a Voice over Internet Protocol (VoIP) modem adapted to convert and output a voice communication IP packet inputted from the WLAN communication unit and an external transmission network and voice data inputted via an analog port into a voice packet for voice communication using the IP; and
a Coder/Decoder (CODEC) adapted to convert and output the voice packet outputted from the VoIP modem into an analog voice band and to perform pulse code modulation of voice data inputted via the analog port and to output the modulated data to the VoIP modem.

10. The IP set-top box according to claim 6, further comprising an interface connected to a camera module used to take an image, wherein the first microcomputer receives the image taken by the camera module connected to the interface and to control a transmission path for image communication.
